(19) United States
(12) Patent Application Publication
(10) Pub. No.: US 2005/0215315 A1
(43) Pub. Date: Sep. 29, 2005

(54) Identification system using a portable instrument issuing an external electromagnetic signal

(76) Inventors: Arthur Miller, Las Vegas, NV (US); Bruce Kusens, North Miami Beach, FL (US)

Correspondence Address: Morishita Law Firm, L.L.C., Suite 850, 3800 Howard Hughes Pkwy., Las Vegas, NV, 89109, US

(21) Appl. No.: 11/066,670

(22) Filed: Feb. 25, 2005

Related U.S. Application Data
(63) Continuation-in-part of application No. 09/811,182, filed on Mar. 16, 2001, now abandoned.

(51) Int. Cl. A63F 13/00

(52) U.S. Cl. 463/29

(57) ABSTRACT

A system and method are set forth for tracking activities of a person having on their person an identification instrument which issues coded signals over a limited range. A data structure is provided which includes personal data describing said person including biometric data such as the facial image of the person. When the card is brought into the range of a receiving antenna, the card's signal is received and processed to access and display the person's data including their biometrical data for verification of the person's identity.

### RELATED APPLICATION DATA

This application is a continuation-in-part application of commonly owned and prior filed application U.S. patent application Ser. No. 09/811,182 filed Mar. 16, 2001 and titled “An Identification System Using a Portable Instrument Issuing An External Electromagnetic Signal.”

### FIELD OF THE INVENTION

The present invention relates to identification systems and methods and more particularly to systems and methods for identifying an individual using a carried instrument which issues an external electromagnetic signal.

### BACKGROUND OF THE INVENTION

In the casino industry, casinos have been known to track the play of individual players in order to establish a historical reference or “rating” by which to evaluate players as to their gaming habits and additionally to reward such players with “comps” in the form of meals, show tickets or the like. These comps establish goodwill between the player and casino and foster a degree of customer loyalty towards the establishment. Methods currently used within the industry are limited in scope and capability.

Casinos also may rate players based upon a theoretical win profile (TWP) which is formulated as a predictor of the revenues which may be expected by the casino from that player correlated to a time or occurrence reference such as per visit to the casino, per hour, per day, or the like. Depending upon the player's TWP and/or wagering history, the casino may offer different level comps to a player or otherwise treat a player differently. For example a player's TWP may be calculated based upon (1) the particular game being played, (2) the player's wagering behavior, i.e. the player's average bet and (3) the period of time the player plays the particular game in a single session, or a single day, or per casino visit. By knowing the average (calculable) hold percentage, or house edge. (e.g. Blackjack has approximately a 2% hold) the amount the casino may expect to win can be computed. Other techniques can be used by a casino to compute the TWP. For example, the TWP may be computed based upon the casino's knowledge of the exact amount bet and amount won by the player in prior gambling sessions, (e.g. though a slot machine accounting system connected to a slot machine played by the player) in which case the TWP is actually based upon the true win-loss history of the player).

Traditionally, only gamblers playing high stakes table games such as Blackjack, Craps and Baccarat were tracked because the amounts and frequency of the wagers justified the additional efforts and warranted the special attention given these types of players to encourage their play at the casino. The personal attention provided these special customers, and the awarding of comps indicated and justified by the information obtained through such tracking of gaming habits created goodwill for the casino and promoted player loyalty.

With the growth of gaming as entertainment, casinos have expanded their tracking and comping policies to cover more players and extend the practice to gaming machine players as well. Typically, a player is issued a player card which includes a machine-readable magnetic strip encoded with data which identifies the player. A host processor collects the player's name, address and card code and an updateable player file is established. When the player wishes to play a gaming machine, the player inserts this card into a card reader at the machine. This card reader interfaces with the host processor such that each time the player makes a wager at the gaming machine, “comp points” relating to the wager are accumulated. Such comp points may be awarded based upon amounts won (pay outs) at the machine as well, or may be based upon a combination of “coin in” (amount wagered) and “coin out” (amounts won by the player). Thus these player tracking systems track the level of play, (amounts wagered), and award comp points according to wagers or wager results. Additionally the player's TWP may be updated to indicate the player's wagering history. Based upon the accumulated comp points and/or TWP the player may receive meals and discounts in an effort to promote goodwill and customer loyalty.

Similarly, and with continued reference to the prior art, players with player cards can accumulate comp points for gambling at table games such as Blackjack. When a player sits down at a table game, the player may hand his or her card to the dealer or floor supervisor who “swipes” the card through a reader to access the player's account and record the gaming session start time. A floor supervisor would then periodically observe the wagers being made to estimate the average wager made by the player. When the player ends the gaming session the floor supervisor swipes their card once again and returns it to the player. The supervisor then inputs the average bet information on a local computer terminal, based upon length of play, the average wager per hand as observed, and the average number of hands played at that table per unit time as well as any other information thought to be pertinent, e.g. the types of wagers made by the player. Comp points are awarded to the player's account based on this information.

Attempts have been made to automate the collection of player tracking data relating to play at table games. Bennett et al., U.S. Pat. No. 5,586,936 issued Dec. 25, 199, discloses a player tracking system wherein the player inserts their tracking card into a reader at their seat at the table, such card reader then communicating with a host processor and a local printer which prints a player tracking slip to be completed by the floor supervisor.

One drawback of such magnetic strip card systems above is that the player must hand his or her card to a floor person or insert the card in a reader while playing, and then remember to remove the card when he or she completes play. Such card handling requirements are inconvenient for the player, and often are defeated when the player forgets to retrieve his or her card at the end of their session, causing erroneous data capture from the just-completed session, and precluding further tracking unless the card is located again, or a new card is issued (and cross-indexed to the old). Not only do multiple cards for a single player complicate the mechanics of player tracking, but it also creates the potential for comps to be redeemed by the wrong individual, the person who chanced upon the deserted card.

Furthermore, systems now attempt to track so many players that the personal component, and the concept of greater attention being paid to tracked players is lost. It is no longer feasible for casino personnel to recognize all tracked players so as to approach each player and greet him or her by name. While this problem arises due to the greatly increased number of players being tracked, it is exacerbated as player cards can be passed between persons, and used by other than the intended player. There is no effective technique to readily confirm the identity of a player presenting a tracking card, whether the player is presenting the card to record a gaming session or to receive a comp such as a free meal. While casino staff could request photographic identification, players, particularly the high-rollers for whom such tracking systems were initially developed, may become offended that the casino does not recognize them. Also, new casino personnel receive no data from the tracking system on which to base a visual identification of the player.

There is therefore a need to provide a quick and reliable system which allows passive capture of player identification with no need to handle the card or other device manually, either to hand it to casino personnel, or to insert the device in a reader. It would be beneficial if, in addition to the above, the device had provided the ability to provide such information as might assist in ready identification of the player without requiring the player to produce confirming identification documents. Such a capability would make it easier for casino staff to recognize, and perhaps personally greet, such tracked players, even if they had never met them.

This device could provide further benefit as it would facilitate locating individuals in an environment such as a casino, particularly in the event of an emergency.

Such a device may also prove useful in other settings where there is a need for passive identification along with visual verification of identity. This could be effective in banks, airline ticket counters and security gates, and even hospitals, where there is a need to quickly, and accurately, identify a potentially large group of individuals.

### SUMMARY OF THE INVENTION

There is, therefore, set forth according to the present invention a system and method for providing for the passive identification of an individual who is carrying on their person a portable instrument in the form of a card or token that does not require the individual to handle the device manually or pass the device through a reader. Further, a visual verification of the identity of a person is possible by interfacing the above identification means with a computer display linked to a data structure containing a stored picture of the individual.

Accordingly, a system is set forth identifying a system which includes a host processor adapted to maintain a data structure containing personal identification data and other desired information, such as TWP and comp points for a casino, to enable efficient and accurate identification of each pertinent individual, and which furthermore maintains a data representative of a visually distinguishable biometrical feature of the person such as their facial image.

The illustrated embodiment includes a portable instrument issued to each person, each such instrument including means for emitting an externally-receivable, identifiable, coded signal. For example, the instrument may be a card which includes a battery-powered transmitter or transponder which, either continually or when prompted, sends a discrete, coded, electromagnetic or ultrasonic signal of limited range. For a passive transponding card, a stationary transmitter/receiver sends an interrogating signal to power and prompt the portable instrument to transmit its coded signal to be received by the stationary transmitter/receiver. For a transmitting card, the card at timed intervals issues its coded signal to be received by a receiver. The network of stationary transmitters/receivers then decodes the signals received to identify the transmitting card, validate its authenticity, and correlate the signal with the appropriate player card. In the illustrated embodiment the card and stationary antennae preferably employ “BLUETOOTH™” or “BLACKFIN™” wireless data transmission protocols and standards as presently known in the art.

The stationary receiver or transmitter/receiver sends captured player card data to a local computer host processor which holds the card code, and the location at which it was detected. If appropriate, the code is then sent to a central host processor which correlates the card number to the information maintained in the player identification data structure identifying the tracked player, and providing such other player data as may be available. The central processor is adapted to correlate the card number to the player account for the individual to whom the card was assigned and recall and display at a suitable local display the player identification data including biometrical data such as the facial image of the person for verification purposes. Protocols may be adopted that incorporate a minimum time component, requiring player's card to be in communication with the receiver for a minimum period of time, distinguishing a player engaging in the tracked activity from a mere passerby. The received signal strength/timing may be used to triangulate the position of the instrument (and hence of the person possessing the instrument) to accurately locate an individual in a larger setting, e.g. to find the person in the casino.

A primary object of the present invention is to provide a tracking system capable of detecting and accurately reporting the presence of a carried tracking instrument within a defined area of space. Another object of the present invention is to provide a tracking system capable of functioning when more than one tracking instrument is within the defined area at the same time.

A primary advantage of the present invention is that it provides for automatic detection and recognition of the person carrying the tracking instrument without any action on the part of that person. The deviceholder need not physically present the device, nor even swipe the card through, or insert the card into, a reader; the device must simply be carried.

Another advantage is that the system and method permits employees to visually identify and personally greet a patron carrying such a tracking device without any action by the patron. This enables casino personnel to verify identity and to offer a personal greeting to the player, thus promoting good will.

Another advantage is that the system and method permits installation in congested areas such as, for example, a casino floor. Tracking may be general, such as finding the instrument in the live game pit area, or it may be specific such as locating the instrument at a specific table.

### BRIEF DESCRIPTION OF THE DRAWINGS

FIG. 1 shows a block diagram of the system according to the present invention;

FIG. 2 is a block diagram of the player carried instrument;

FIG. 3 shows a computer terminal display or hard copy of the type produced according to the system and method of the present invention;

FIG. 4 illustrates further embodiments for the arrangement of receivers or transmitter/receivers on the casino floor; and

FIG. 5 shows a logic diagram for a further embodiment of the present invention.

### DESCRIPTION

1. System Overview

While the following description describes a system and method according to the present invention to be used to track the play of and identify players in the casino industry, and specifically for tracking the play of players at Blackjack tables, it is to be understood that the system and method could be used to track players playing Baccarat, Craps, Pai Gow or the like. It is also to be understood that the system and method according to the present invention can be used to track the play of players playing slot machines as well as activity at restaurants, stores, shows and other casino facilities. It should be further understood that the system and method could be used in other applications such as in the banking or security industries.

When an individual such as a casino player desires to be tracked (or, when in individual is in a situation where his employer, regulations or contract requires tracking), that individual may register with the tracking system at a data entry station. The data entry station is a computer terminal or a computer system of the personal or mini computer type known in the art. As described below, the station includes display and data input devices such as a keyboard a mouse or a touch screen of known construction. A video or digital scanner device as well as a device to encode the tracking device are also included.

When a player registers at the data entry station, casino personnel creates a personal folder or file for that player and inputs, by the data entry means, pertinent identification data such as name and address and any such other information which may be used in casino player tracking systems known in the art. As hereinafter described, to input data relating to the facial appearance of the player, a digital scanner may be used to scan a photograph or photographic identification card which contains a photograph. Alternatively, a digital camera may be used to capture data corresponding to the facial appearance of the player.

The player identification data thus acquired is used to establish a personal account or file in a data structure. Where the system and method is used in a casino environment to track play by players, the player's account will further include updateable information regarding any player “comp” points awarded based on the player's wagering activities. A theoretical win profile (TWP) file may also be created and maintained, indicating the revenues which might be predicted from the player, per visit to the casino, as computed from their prior tracked history, and based on algorithms already known in the art.

Each player's account is assigned an account number which acts as an index to the player tracking data structure to access the player's data, and for updating the player's “comp” points, TWP, or other personal data (e.g. address, phone number, or the like). Such player identification data, including biometric identification data, is stored within the data structure, indexed by a unique player account number assigned to the specific player.

When a player first enters the establishment, such as when the player checks in to a casino-resort, the player may be issued a tracking instrument such as a tracking card as hereinafter described. This card transmits for a limited range a coded signal unique to the card, either continually or in response to an interrogating signal which may is based upon a Bluetooth™ or Blackfin™ protocols and standards. A network of receivers is located throughout the environment receive the signal from the card. The card, and in particular its signal code, are correlated to the player's tracking number when the card is issued to the player. Thus the card coded signal is matched to a specific player and that player's account. When the player leaves the casino at for example the conclusion of their stay, the card may be returned and the correlation between that player's account and that card's signal code is cancelled so the card may be issued to another player. Alternatively the card may be permanently assigned to a single player for him/her to carry for each visit to the casino. This is particularly applicable where a player is either a frequent visitor to a tracking location, such as a nearby resident, or where multiple locations share a tracking system, as for example affiliated casinos.

It should be understood that many casinos have established player tracking systems based upon machine readable cards or the type referred to in the Background. Thus, for these systems, player account numbers have already been assigned. The system according to the present invention can, as described below, be easily integrated into an existing system by providing the signal emitting instruments hereinafter described and acquiring biometric data, e.g. a facial picture, of the customer, but retaining the player account numbers previously assigned.

According to the method and system of the present invention, when a player approaches a casino pit area, e.g. a group of Blackjack tables, or sits at a gaming machine, carrying a transmitting card, that card transmits its code to be received by one or more receivers, whereupon personal data relating to the player can be obtained from the tracking system data structure. Based upon the locations of the receivers receiving the signals, as well as the signal strength of the coded signal, the location of the card can be determined. For example, the signals may be processed to determine that the instrument is in the casino pit area (or specific area in the pit area). The card code signal may be used to recall from the tracking system data structure, such as the facial image of the player. Display of this information to casino personnel would enable such personnel to recognize the player, and perhaps personally greet him or her. Furthermore, the player's play can be tracked without the player ever having to present a tracking card to an attendant or take any other overt action.

In one embodiment, the signal emitting instrument, e.g. card, is a transponder and may be a passive transponder powered by the signal received from a transmitter/receiver. However, the card may have a self-contained power source, and may act as a transponder or may initiate the communication with the receiving device by periodically issuing its coded signal. If such coded is received over a predetermined time period, indicating that the person carrying the card is remaining in the area of the receiver, the system identifies the card signal, makes the correlation to the player's account number, and provides access to player identification data including, if desired, the display at a local display of such data including the biometric data as may be required to confirm the identity of the player.

2. The System

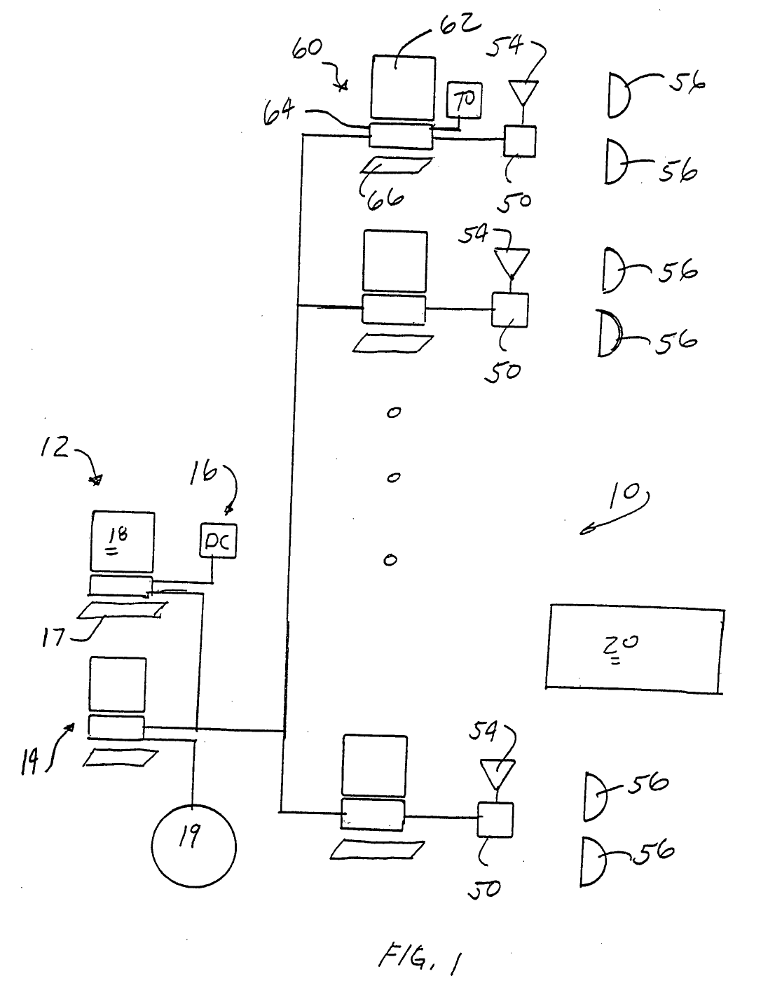

Referring to FIG. 1, the system 10 of the present invention is shown. A data entry station 12 is provided for entering of player account data. The data entry station 12 is in communication with a host computer 14. The pertinent player identification data described above is entered at the data station 12. Biometric data such as the facial image of the player as a scanned image or a digital camera 16 photograph is also entered at the data entry station 12. Alternatively this biometric data may be acquired later such as when the player is assigned their identification instrument as hereinafter described. Other data such as name and address is entered with suitable and known data entry means such as a mouse, scanner, touch screen or keyboard 17. A display 18 is provided at the data entry station 12. The data entry station 12 may be a suitable personal computer located, where the system is used to enroll players at a casino, at a player registry booth. The player identification information is then transferred to the host computer 14 and is configured for storage into a data structure 19. The player's data is stored under an assigned and unique account number in the data structure.

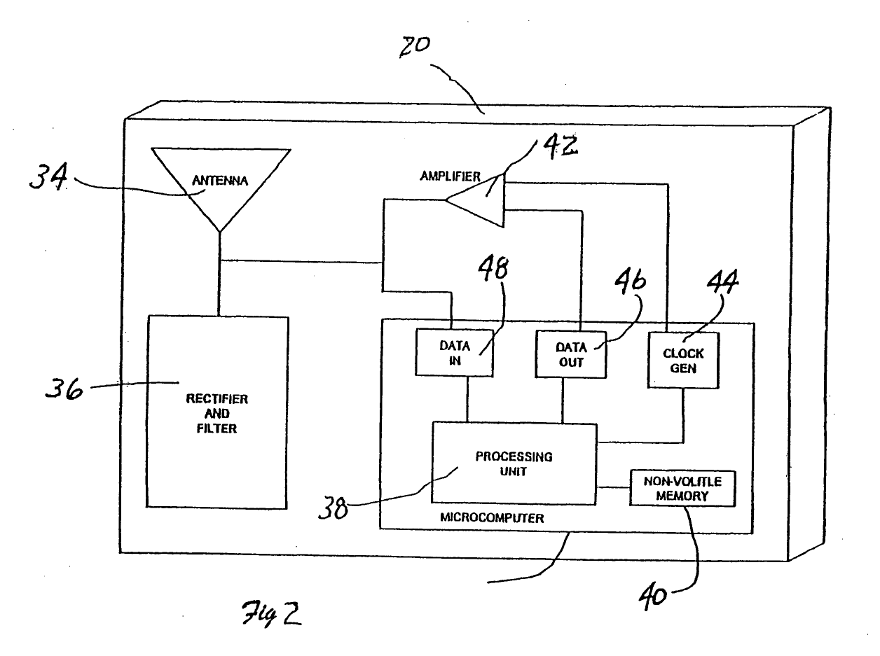

When the customer's activities are to be tracked or otherwise accounted for according to the present invention, the customer is issued an identification instrument shown as a tracking card 20. The issuance of the tracking card 20 may occur when the player checks into a casino-hotel or at any time when the player wishes, or the casino desires the player, to have the card 20. FIG. 2 is a block diagram for a tracking card 20 which, in lieu of a card may be a token or a bracelet, necklace, or the like, suitable for housing the components hereinafter described and to be issued to, and carried by, the player.

Where the card 20 is configured as a transponding card, a triggering signal is periodically emitted by local, stationary transmitters/receivers 54 described below, detected at card antenna 34, and rectified and filtered into a direct current by the rectifier and filter 36. Preferably, a frequency of about 2.46 Hz is selected for the signal. Preferably the card 20 is constructed to include a battery power supply (not shown). The direct current then supplies power to the preprogrammed micro-processing unit 38 that controls the operation and initiates transmission of a coded, card-specific, signal stored in card 20 memory 40. Preferably each card 20 has stored a unique and discrete signal code, e.g. “xxxxxx”, which identifies the card 20. The signal code may be programmed into the card 20 by the facility or by the manufacturer. As stated above the code signal is configured to be operable according to Bluetooth™ or Blackfin™ protocols. In response to the card antenna 34 receiving a prompting signal from a transmitter/receiver 54, the card responds by transmitting its unique code “xxxxxx”. The signal may be encrypted to prevent counterfeiting or interference with the signal.

The signals transmitted may be electromagnetic or ultrasonic.

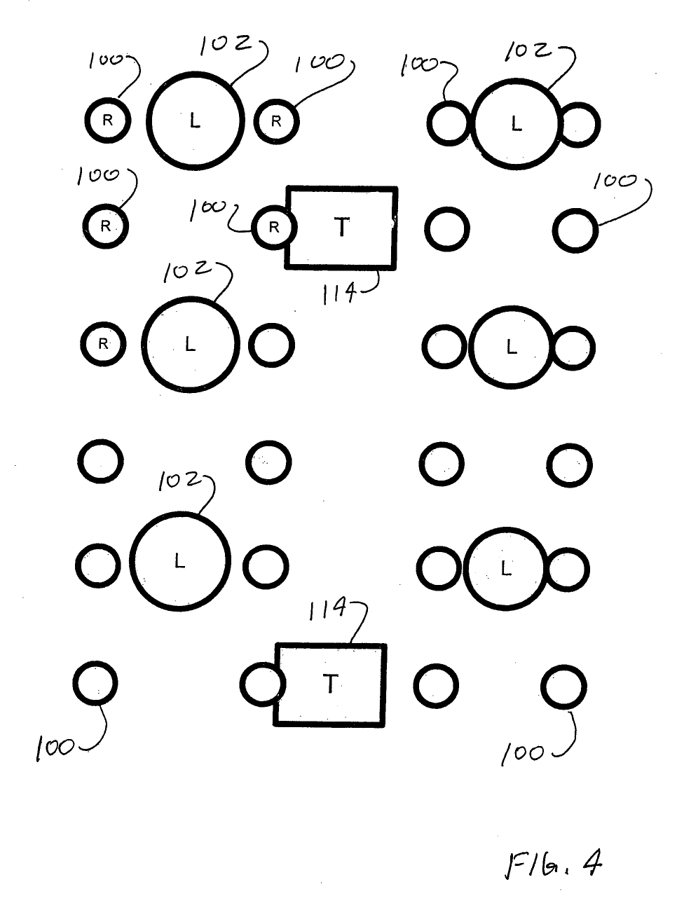

Again referring to FIG. 1, stationary transmitter/receivers 50 are positioned in the areas where tracking using the card 20 is to occur. According to one approach, based upon the known range the signal transmitted by the card 20, transmitters/receivers are position such that only one transmitter/receiver will pick up the any given signal. According to another approach as suggested in FIG. 4 discussed later, a network of transmitter/receivers is position throughout the environment such that several can receive a signal, and then determine a more accurate position of the transmitting instrument by triangulation of the receivers/transmitters detecting a signal.

Returning to FIG. 1, for example, a transmitter/receiver 50 may be located in a gaming pit for a casino including several gaming tables 56 as shown. As an example, one transmitter/receiver 50 may be located for every group of three tables 56. The transmitter/receiver 50 periodically issues interrogating signals, also according to Bluetooth™ protocols, to prompt any cards 20 in its area and range of signal, to respond with their coded signals. The range or field of influence of the interrogating signals and card 20 responsive signals may range from approximately three feet to three hundred feet depending upon signal strength. When the card 20 enters the reception of one of the transmit antennae 54, the card antenna 34 receives an interrogating signal and, if the interrogating signal meets or exceeds a preselected threshold strength, i.e. the card 20 is within the selected range, the card 20 responds with it's coded signal “xxxxxx” which is in turn received by the receiving antenna 54 for processing. Based upon the power of the card 20, the coded signal may have a limited range of ranging from three to three hundred feet.

In lieu of multiple transmitter/receivers 50, a single transmitter may periodically issue interrogating signals and separately located and local receivers receive the transponding signals from cards 20 within the limited range of the car's 20 signal strength.

In lieu of the cards 20 being transponders, i.e. responding only when receiving an interrogating signal, each card 20 may be a transmitter periodically transmitting its individual coded signal. When the signal comes within the range of a receiver 50, the card's 20 coded signal is received for processing.

The signal sent by the card 20 (or transmitter/receiver where the card 20 is a transponder) may optionally be ultrasonic. An advantage to an ultrasonic signal is that if it is received by multiple receivers, the position of the card 20 may be triangulated based upon the speed of sound and comparing signal-receipt times.

When the card 20 has issued its coded signal and the same is received by a receiver 50, the receiver 50 issues a data signal to a local processor 60 which may optionally be located in a casino “pit” near the gaming tables. Each local processor 60 includes a display 62, computer 64 and a keyboard 66 for data entry. When a card 20 signal is received, the local processor 60 processes the signals to determine authenticity and compares the signal data to stored parameters to determine whether a tracked player is likely to be gaming in the local pit area as well as to identify the player. For example, the signals from the card 20 may be required to be of a predetermined strength and duration to result in a determination that the person with the card is in the area, has remained in the area, and thus is likely engaged in a gaming activity suitable for tracking. For example, if the card 20 signal is weak and of a short duration, the player is most likely simply passing through near the pit area.

If the threshold parameters of signal, strength and duration are met, the local processor 60 accesses the host processor 14 and the player's account. At the time the player was issued the card 20, the card 20 signal code was correlated to the index in the data structure 19 related to the player and the player's account. Such correlation would typically be administered at the data entry station 12 for example. Then, when the system 10 detects the card 20 signals which correspond to a particular player having a discrete account stored at the data structure, the local processor 60 recalls data specific to the individual player for casino personnel to view at the local processor display 62. If the player's gaming activities are to be tracked or the pit personnel wish to greet the player, the player's biometric data, e.g. facial image, may be recalled at the display 62 so that the player can be recognized and identified. Other data may also be recalled such as the dates of the player's last visit and the like. Thus the pit personnel may look for the player in the area and offer an informed greeting. Addionally, by requiring the casino personnel to match the displayed picture of the player with the player, the personnel will more likely remember the player.

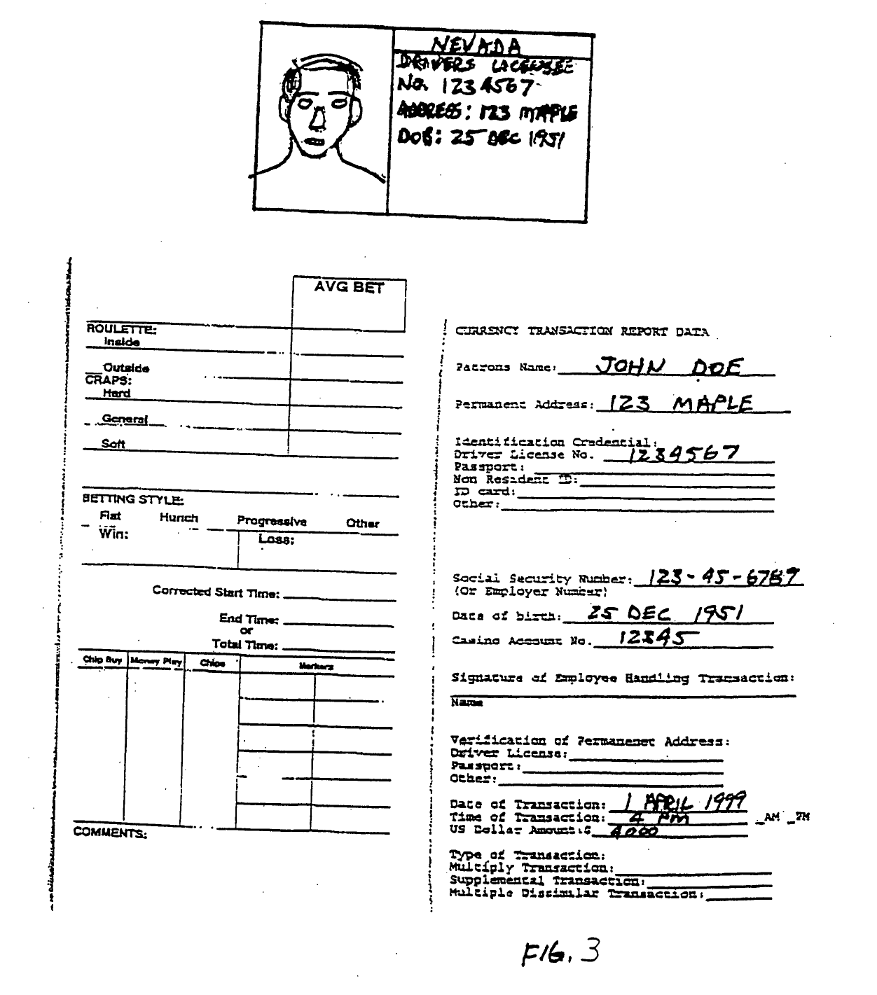

If the casino wishes to track the player's gaming activities, a player tracking slip as suggested in FIG. 3 may be printed out at a local processor 60 printer 70 for tracking data to written down by the casino personnel. At the conclusion of the gaming session by the player, this slip is completed and turned in to a data processing department for entry to update the player's account data. Alternatively the data may be entered at the local processor 60 by the keyboard 66 or by touch screen technology. That is, the pit staff may monitor wagering levels and the play of the player and when the player leaves, enter the pertinent data at the local processor 60.

The data may be transmitted between the local processors 60 and host processor 19 as well as between the receivers 50 and local processors 60 by wired or wireless communication.

When the player concludes their stay, or otherwise no longer requires (or desires) tracking the player may return their issued card 20. Data entry personnel access the system 10 and terminate the relation between the card's 20 code and that player's account number so that the card may be issued to another player. Alternatively, should it be advantageous, the card 20 may be retained by the player and reused at their next visit to the same or an affiliated establishment.

Turning to FIG. 4, an example of the system and method of the present invention is shown where the environment includes a network of receivers. According to this embodiment, a plurality of receivers 100 are positioned throughout the environment where locating (and tracking) of the instrument is desired. Thus in a casino pit area, receivers 100 may be positioned at regular intervals, optionally being located along the ceiling, in the floor, incorporated in the flooring material such as carpet, or in furniture which remains relatively stationary (e.g. gaming tables, but not chairs or stools). Optionally, receivers are located where transmitted signals are not likely to encounter interference from dense objects, hence locating the receivers in or at ceiling level may be a preferred choice.

As described above, the receivers 100 may be configured as “receive only,” recognizing signals from devices (cards 20) transmitting at regular intervals, or may be adapted to receive only based upon a prompting signal generated from a common location or at a limited number of locations thought the casino area. For example, transmitters may be positioned throughout the casino area, be of limited effective range, and be instructed by a controller to transmit prompting signals at timed intervals to induce responses from the cards.

Receivers 100 transmit the received signals to the processor 104 which may be a local processor or a processor common for the system 10 as a whole. The processor 104 processes the signals at 106 to determine the location of the instrument as well as the time the card 20 remains within range of that location. Locating the position of the card 20 may entail determining the location of the receivers 100 receiving the same card 20 code transmissions, the relative strengths of the signals and thereby determining at least an approximate location of the card 20. This locating technique may be determined based upon an algorithm or by empirically measuring receiver signals as a card 20 is presented throughout the area.

Location may be determined based upon the timing of the prompting signals and the receivers receiving the card 20 signals. For example, transponder(s) of limited range may be configured to periodically issue prompting signals and based upon which card(s) 20 respond and knowing the location of the transponder/receiver which prompted the card 20 to respond, a location could be determined.

A combination of sequencing the prompting signals of limited range from known locations in the casino and measuring the card 20 responding signal strengths could also be used.

In addition to determining location the processor 104 also determines at 106 whether the located card 20 is substantially stationary for a period of time, indicative that the person bearing the card 20 is engaged in gaming activity. Accordingly, the processor 104 determines location of the card 20 over a period of time P and correlates the location (L) and time (P), to determine whether to access the data within the data structure for the player to whom the card 20 was assigned. Accordingly at 108 the processor 104 makes an assessment if the acquired and processed data meets criteria which suggests the player is engaging in gaming activities. The processor 104 then accesses the data within the data structure relating to the player to whom the card 20 was issued, if the determined location of the card 20 “L” is in proximity to a gaming table or slot machine for a time period “P”. For example, “P” may be set for thirty seconds with “L” being a given location ± three feet. If the signal data acquired by the receivers 100 do not result in the criteria being met, at 110 the data is recalculated for a next period of time. Thus players with cards 20 walking through the area will not have their data accessed.

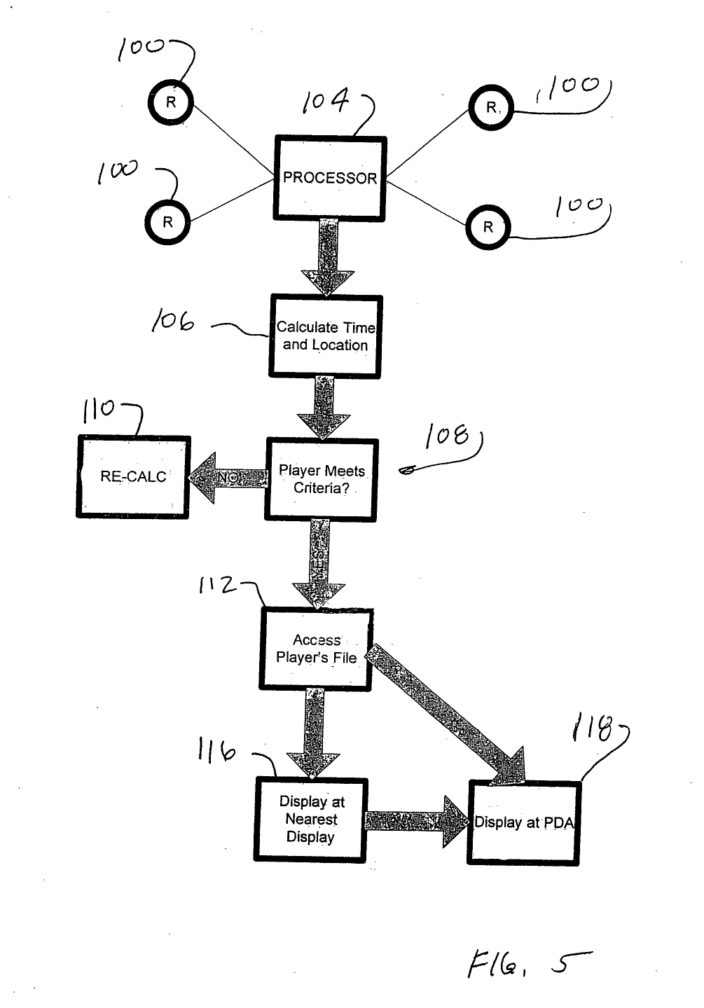

With continuing reference to FIG. 4, the receivers 100 are located relative to locations (L) 102 which may be, for example Blackjack tables, banks of (or individual) slot machines, tables in a restaurant, or the like. When a player possessing a card 20 (carried for example in a purse, pocket or wallet) enters the area, the processor 104 at 106 (FIG. 5) calculates the location and residence time in the area and, if at 108 the criteria established suggest the player is engaged or about to engage in gaming activity, the processor 104 at 112 accesses the data stored in the data structure corresponding to the identified card 20. Selected data such as facial image data retrieved from the player's file may then, under control of the processor 104, be displayed at a terminal T 114 located proximate the determined location of the card 20 at 116. As an example, when a player carrying a card 20 enters the casino Blackjack pit area and lingers there for a period of time, e.g. 30 seconds, the card 20 is identified in the manner described above and the processor 104 accesses the player's file and, at the closest terminal 114 in the Blackjack pit, retrieves and displays the facial image of the player as well as his TWP or other data which rates the player, e.g. average wager, average total wager per gaming session or the like. A supervisor or other personnel can look at the terminal display and use the facial image to recognize the player and offer a personal greeting. Personnel can also verify that the card 20 and player match.

To update a player's rating, as described above, a player rating ticket may be printed and manually completed as described above. Alternatively, an electronic form may be displayed for the player to be completed at the terminal by appropriate personnel.

In lieu of or in addition to the display of player data at a terminal T 114, the system 10 may also provide at 118 for the display of data corresponding to the recorded carrier of the identified card 20 at one of more selected PDAs carried by casino personnel. For example, the casino host assigned to the player may be notified at their PDA when the player card 20 is identified. In this manner the host can locate and greet the player. In further implementations, all personnel PDAs may be notified when any card 20 is first identified in the casino area, or when cards 20 for players meeting certain criteria (e.g. “high rollers”) are identified.

The system 10 may be selectively configurable to locate cards 20 within a small area, e.g. at a specific gaming table, seat at the table, or a specific slot machine, or to retrieve data for cards 20 that are in a larger area such as cards 20 located in the Blackjack pit area or within a particular bank of slot machines.

While the system described herein operates complete unto itself, it can also be interfaced to existing player data structures and computer networks presently installed in gaming establishments. The hardware interface is through a connection such as, for example, a standard RS-232 communications port to the modem interface box. Software drivers will be required to allow the existing computer program to receive tracking numbers from such an interface.

Although the invention has been described in detail with particular reference to these embodiments, other embodiments can achieve the same or equivalent results. Variations and modifications of the present invention will be obvious to those skilled in the art and this disclosure is intended to cover all such equivalents in the appended claims. For example, as stated above, the system of the present invention could also be implemented into the banking and security industries. In the banking industry, for example, a customer would be issued a card of the type described above. When at an automatic teller machine or cashier's counter, an antenna would transmit a signal causing the card to transpond with the customer's account number and data identifying the individual such as a facial image. This data can be stored for purposes of confirming a transaction at an automatic teller machine or displayed for a teller to confirm the identity of the individual.

While certain embodiments of the present invention have been shown and described it is to be understood that the present invention is subject to many modifications and changes without departing from the spirit and scope of the claims presented herein.

1. A system for identifying a person within a predefined area comprising:
a host processor including a data structure, said data structure storing personal identification data for each person to be identified including data representative of a biometrically distinguishable physical feature of the person;
a portable instrument issued to each person, each instrument including a transmitter for issuing an identifiable data signal, at least one of said processor and data structure configured to correlate said data signal with the identification data stored for the instrument issuing each data signal;
a network of spaced receivers in said area to receive data signals and transmit data received to said processor;
said processor adapted to determine the position of any instrument within said area from said data signals, and access said personal identification data for the person issued, and carrying, said instrument; and
a plurality of display terminals to display at least a portion of said personal identification data related to at least one of (a) the assigned carrier of any instrument determined to be in said area or (b) the assigned carrier of any instrument determined in a predetermined location in said area.

2. The system of claim 1 comprising said processor configured to ignore instruments in said area for less than a predetermined period of time, which time is determined to be indicative that a person possessing said instrument is traversing through said area.

3. The system of claim 2 comprising each terminal including a data entry device in communication with said processor, said processor configured to (a) control each terminal display to display biometric identification information to assist in identifying each person associated with any instrument determined to be at least in said area or in a specified location in said area and (b) when instructed by said data entry device, display at least a portion of said personal identification data stored in said data structure.

4. The system of claim 3 comprising a plurality of terminals spaced in said area, said processor configured to control each display terminal to display information identifying each person associated with any instrument determined to be in a predetermined spatial relationship to said display terminal.

5. The system of claim 2 comprising said processor configured to control each display terminal to display data representative of a biometrically distinguishable physical feature of each person associated with any instrument determined to be in at least one of said area or specified location in said area.

6. The system of claim 5 comprising a plurality of terminals spaced in said area, said processor configured to control the display terminal to display data representative of a biometrically distinguishable physical feature of each person associated with any instrument determined to be in a predetermined special relationship to said display terminal.

8. A system for identifying a person within a predefined area of an establishment comprising:
a host processor including a data structure, said data structure storing personal identification data for each person to be identified including data representative of a biometrically distinguishable physical feature of the person;
a portable instrument issued to each person, each instrument including a transmitter for issuing an identifiable data signal, at least one of said processor and data structure configured to correlate said data signal with the personal identification data stored for the person issued the instrument transmitting said data signal;
a network of spaced receivers in said casino area to receive said data signals and transmit said stored personal identification data to said processor;
said processor adapted to determine the position of any instrument from said data signals received from by said receivers from said instruments, and access said personal identification data for the person issued said instrument; and
at least one display terminal to display at least some of said personal identification data which correlates to at least one of (a) any instrument determined to be in said establishment or (b) any instrument determined in a predetermined location in said establishment.

9. The system of claim 8 comprising said processor configured to ignore instruments in said establishment, or at a predetermined location in said establishment for less than a predetermined period of time, indicative that a person possessing said instrument is traversing through said establishment, or through said location in said establishment.

10. The system of claim 8 comprising each terminal including a data entry device in communication with said processor, said processor configured to (a) control each display terminal to display information identifying each person associated with any instrument determined to be in at least one of said establishment or specified location within said establishment and, (b) when instructed by said data entry device, display any personal information data stored in said data structure correlated to said instrument.

11. The system of claim 8 comprising a plurality of terminals spaced in said area, said processor configured to control each display terminal to display information identifying each person associated with any instrument determined to be in a predetermined spatial relationship to said display terminal.

12. The system of claim 8 comprising said processor configured to control each display terminal to display data representative of a biometrically distinguishable physical feature of each person associated with any instrument determined to be in at least one of said establishment or location within said establishment.

13. The system of claim 8 comprising a plurality of terminals spaced in said area, said processor configured to control each display terminal to display data representative of a biometrically distinguishable physical feature of each person associated with any instrument determined to be in a predetermined spatial relationship to the terminal.

14. A method for identifying a player likely engaged in gaming activities within a casino:
(a) providing a processor including a data structure;
(b) including within a player's recorded data, both personal information data and data corresponding to a facial picture of the player, such recorded data indexable by an assigned player number;
(c) issuing a portable instrument to the players configured to ultrasonically or electromagnetically transmit a data signal, such signal being unique to such instrument, and dynamically correlatable to a player's indexing player number;
(d) locating a plurality of receivers within the casino area to be occupied by players engaging in various gaming and non-gaming activities, each receiver configured to (i) receive data signals from instruments located proximate thereto and (ii) transmit said data signals to said processor, (e) processing the data signals received by the receivers to discriminate between players likely engaging in gaming activity and passersby and, for players determined to likely engaging in gaming activities, accessing the personal information data correlated to the instrument issuing said data signals; and
(f) displaying at a display terminal such data as may be determined for each player determined during step (e) to be engaged in gaming activity.

15. The method of claim 14 comprising locating receivers and displays at spaced locations within the casino, processing said data signals to discriminate between players likely engaging in gaming activity and passersby and, for players determined to likely engaging in gaming activities, determine the location of the nearest display and displaying at said nearest display player information data associated with each player determined to be likely engaged in gaming activity.

16. The method of claim 15 comprising displaying at least data corresponding to the facial image of said players.

17. The method of claim 14 comprising printing a player tracking form for any selected player whose file was accessed during step (e), rating the player using the tracking card and entering said rating data into said player's indexed portion of said data structure.

18. The method of claim 14 comprising displaying a player tracking form on a selected display terminal for any selected player whose file was accessed during step (e), rating the player by entering information into said tracking form and entering said rating data into said player's indexed portion of said data structure.
